(19) United States
(12) Patent Application Publication
(10) Pub. No.: US 2010/0308549 A1
(43) Pub. Date: Dec. 9, 2010

(54) Temporary snowboard binding apparatus

(76) Inventor: William Rivard, Menlo Park, CA (US)

Correspondence Address: William Rivard, 1062 Arbor Rd., Menlo Park, CA, 94025, US

(21) Appl. No.: 12/455,693

(22) Filed: Jun. 4, 2009

(51) Int. Cl. B62B 13/00; A63C 9/08; A63C 9/00

(52) U.S. Cl. 280/14.21; 280/612; 280/14.24

(57) ABSTRACT

One embodiment of the present invention sets forth a temporary binding apparatus for binding a snowboard boot to a snowboard. A magnetic element is affixed to the snowboard and a permeable element is affixed to the snowboard boot. The magnetic element and permeable element are configured to develop a binding force that is a function of a rotation angle between the magnetic element and permeable element. In an engaged configuration, the permeable element is aligned with the magnetic element and the binding force should be sufficient to enable a snowboarder to readily perform certain simple maneuvers, such as dismounting a chairlift. A pivot means is formed by joining the permeable element and magnetic element. The pivot means enables the snowboarder to easily rotate the permeable element into misalignment with the magnetic element, thus decreasing the binding force and enabling easy detachment of the snowboard boot from the snowboard.

### BACKGROUND OF THE INVENTION

1. Field of the Invention

Embodiments of the present invention relate generally to snowboard equipment and, more specifically, to a temporary snowboard binding apparatus.

2. Description of the Related Art

Snowboarding is an increasingly popular downhill winter sport. A person who practices the sport of snowboarding is commonly referred to as a snowboarder. One of the primary goals of snowboarding is for the snowboarder to enjoy a downhill ride on a snowboard. The snowboarder typically dons a pair of snowboard boots, which may be attached independently to the snowboard using a highly robust binding mechanism, such as a set of straps or mechanical latches. The binding mechanism associated with the snowboard boots is commonly referred to as “bindings.” The bindings include a front binding, positioned generally to the front (downhill end) of the snowboard, and a rear binding, positioned at the rear (uphill end) of the snowboard. While riding a snowboard down a slope, the snowboarder stands on the snowboard and points one end of the snowboard in a generally downhill direction while performing various maneuvers. Some snowboarders may perform maneuvers that alternate which end of the snowboard is pointed down hill. While riding styles and different maneuvers may vary with respect to which end of the snowboard is pointed downhill at a particular time, a rear snowboard boot, or simply “rear boot,” is designated herein as a snowboard boot the snowboarder prefers to unbind and keep detached from the snowboard when riding a chairlift. A front snowboard boot, or simply “front boot,” is designated herein as a snowboard boot the snowboarder prefers to keep bound and attached to the snowboard while riding the chairlift. When attached to a binding, the front boot is conventionally bound to the front binding and the rear boot is conventionally bound to the rear binding.

Prior to snowboarding down a hill, the snowboarder typically rides the chairlift up the hill. Snowboarders are conventionally required to bind the front boot to the front binding of the snowboard and un-bind the rear boot from the snowboard before boarding the chairlift. The snowboarder normally dismounts the chairlift at the top of the chairlift path, known as a dismount point. Immediately after dismounting the chairlift, the snowboarder typically attempts to ride the snowboard a short distance from the dismount point to an arbitrary attachment location where the snowboarder may safely attach the rear boot to the rear binding. Riding conditions at the chairlift dismount area are generally much less demanding than many surfaces and slopes that the snowboarder may wish to subsequently ride, but the fact that the rear boot is not attached to the snowboard makes dismounting the chairlift and riding to the attachment location relatively difficult. In fact, this can be a very awkward maneuver, even for relatively experienced snowboarders, because only partial control of the snowboard is possible with just the front boot securely bound to the snowboard.

FIG. 1 illustrates a top view of a snowboard 110 configured to include a front binding 124 and a rear binding 120, according to the prior art. A stomp pad 150 may be affixed to the snowboard 110 to provide some frictional grip provided by a rough or spiky surface that the snowboarder may step on to with the rear boot before the snowboarder has an opportunity to bind the rear boot to the rear binding. While the stomp pad provides the snowboarder with a place to step with the rear boot that is less slippery than the overall snowboard surface, very little additional control is actually gained by stepping on the stomp pad. Therefore, the snowboarder still faces a significant challenge when dismounting a chairlift, even when a relatively good stomp pad is available.

As the foregoing illustrates, what is needed in the art is a means for a snowboarder to gain greater overall control of their snowboard when their rear boot is not bound to the rear binding.

### SUMMARY OF THE INVENTION

Embodiments of the invention provide a snowboard binding apparatus for temporarily binding a boot to a snowboard. A boot binding assembly having a permeable element and a concave structure is configured to bind to a magnetic binding assembly having a magnetic element and a convex structure. Engaging the concave structure with the convex structure forms a pivot means that allows a user to rotate the boot binding assembly with respect to the magnetic binding assembly about a rotation angle. A binding force that is a function of the rotation angle is developed between the magnetic element and the permeable element. A first binding force is developed for a first rotation angle, and a second binding force that is smaller than the first binding force is developed for a second rotation angle. The user may disengage the boot binding assembly from the magnetic binding assembly by rotating the boot binding assembly to approximately the second rotation angle, thereby reducing the binding force for easy detachment.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a top view of a snowboard configured to include a front binding and a rear binding, according to the prior art;

FIG. 2A illustrates a side view of a temporary binding apparatus configured to bind a rear boot to a snowboard, according to one embodiment of the invention;

FIG. 2B illustrates the snowboard configured to include a rear binding and a magnetic binding assembly, according to one embodiment of the invention;

FIG. 3A is a detailed cross-section of the boot binding assembly and the magnetic binding assembly attached to the top surface of the top side of the snowboard, according to one embodiment of the invention;

FIG. 3B is a detailed cross-section of the boot binding assembly and the magnetic binding assembly embedded within the snowboard, according to one embodiment of the invention;

FIG. 4A illustrates a binding rotation angle between the boot binding assembly and the magnetic binding assembly, according to one embodiment of the invention;

FIG. 4B illustrates binding force as a function of binding rotation angle, according to one embodiment of the invention;

FIG. 5A is a cross-section of an exemplary magnetic binding assembly and a matching boot binding assembly, according to one embodiment of the invention;

FIG. 5B illustrates a top view of an exemplary boot binding assembly with three permeable components, according to one embodiment of the invention;

FIG. 5C illustrates a top view of an exemplary magnetic binding assembly with three magnetic components, according to one embodiment of the invention;

FIG. 5D illustrates the boot binding assembly and the magnetic binding assembly aligned in an engaged configuration, according to one embodiment of the invention;

FIG. 5E illustrates the boot binding assembly and the magnetic binding assembly rotated in a disengaged configuration, according to one embodiment of the invention;

FIG. 6A illustrates the boot binding assembly comprising two permeable components and the magnetic binding assembly comprising two matching magnetic components, according to one embodiment of the invention;

FIG. 6B illustrates the boot binding assembly comprising two permeable components and the magnetic binding assembly comprising two matching magnetic components, according to an alternative embodiment of the invention;

FIGS. 7A illustrate a side view of a concave structure configured to encircle one or more permeable components, and a convex structure, configured to encircle one or more magnetic components in the disengaged configuration, according to one embodiment of the invention;

FIGS. 7B illustrate a side view of a concave structure configured to encircle one or more permeable components and a convex structure configured to encircle one or more magnetic components in the engaged configuration, according to one embodiment of the invention;

FIG. 7C illustrates a top view of the concave structure configured to encircle the one or more permeable components, according to one embodiment of the invention;

FIG. 7D illustrates a top view of the convex structure configured to encircle the one or more magnetic components, according to one embodiment of the invention;

FIG. 8 illustrates a side view of magnetic component configured to bind to a permeable component, according to one embodiment of the invention;

FIG. 9A illustrates a magnetic element configured to include a magnetic component having a beveled edge and a casing having a matching beveled edge, according to one embodiment of the invention;

FIG. 9B illustrates a magnetic element comprising a magnetic component and a flux guide, according to one embodiment of the invention;

FIG. 10A illustrates a bottom view of the boot binding assembly and a corresponding top view of magnetic binding assembly, according to one embodiment of the invention;

FIG. 10B illustrates a side view of the concave structure and convex structure in the disengaged configuration, according to one embodiment of the invention;

FIG. 10C illustrates a side view of the concave structure and convex structure in the engaged configuration, according to one embodiment of the invention;

FIG. 10D illustrates a side view of the boot binding assembly and magnetic binding assembly in the disengaged configuration, according to one embodiment the present invention; and

FIG. 10E illustrates a side view of the boot binding assembly and magnetic binding assembly in the engaged configuration, according to one embodiment the present invention.

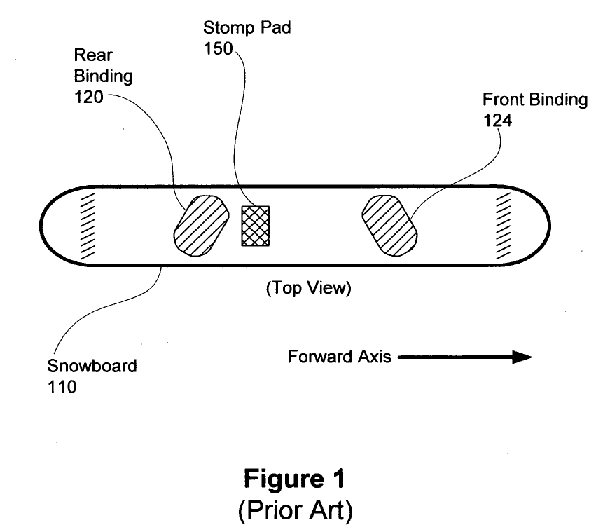

### DETAILED DESCRIPTION

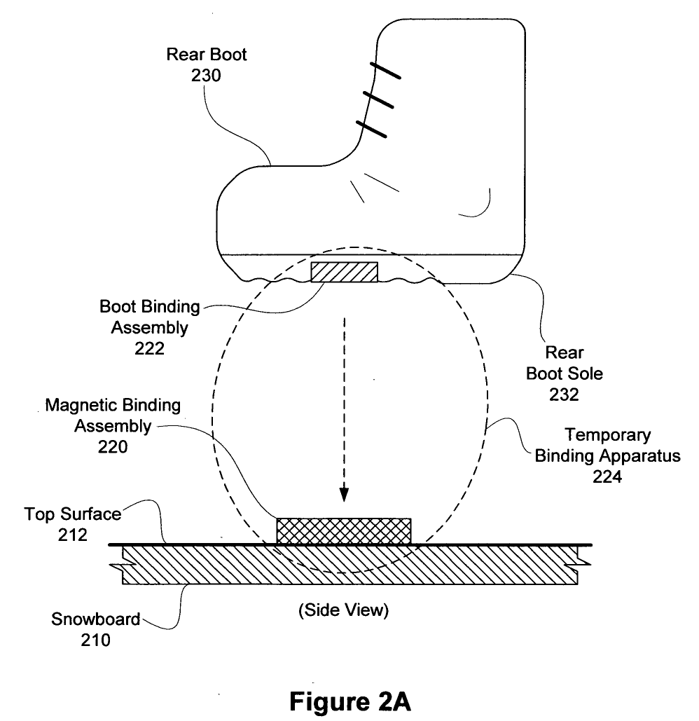

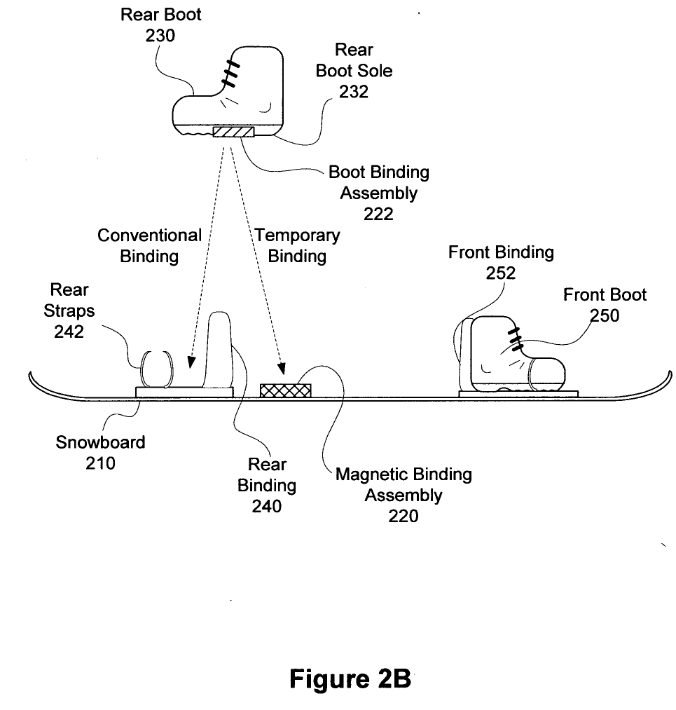

FIG. 2A illustrates a side view of a temporary binding apparatus 224 configured to bind a rear boot 230 to a snowboard 210, according to one embodiment of the invention. The rear boot 230 includes a rear boot sole 232 disposed on the underside of the rear boot 230. The temporary binding apparatus 224 comprises a boot binding assembly (or simply “boot assembly”) 222 and a magnetic binding assembly (or simply “magnetic assembly”) 220. The magnetic binding assembly 220 comprises a temporary binding. The boot binding assembly 222 should be robustly attached to the rear boot sole 232. The snowboard 210 includes a top side with a top surface 212 and bottom side with a bottom surface (not shown), which may interface with a ground surface such as snow. The magnetic binding assembly 220 should be robustly attached to the snowboard 210 at the top surface 212.

In one embodiment, the boot binding assembly 222 is configured to be attached to the underside of the rear boot sole 232. Alternatively, the boot binding assembly 222 may be configured to be inserted into a cavity in the rear boot sole 232. The boot binding assembly 222 may be implemented as a modification to a conventional boot. The modification may be performed by a manufacturer or by an end user.

In an alternative embodiment, the boot binding assembly 222 is configured to be embedded in the rear boot sole 232. For example, rear boot 230 may be manufactured to include the boot binding assembly 222 as an integral component of the rear boot sole 232.

FIG. 2B illustrates the snowboard 210 configured to include a rear binding 240 and a magnetic binding assembly 220, according to one embodiment of the invention. A snowboarder may bind a front boot 250 into a front binding 252, which is robustly attached to the snowboard 210. As is known, the snowboarder may bind the rear boot 230 to the rear binding 240, which is robustly attached to the snowboard 210. For example, prior to riding down a mountain slope, the snowboarder may conventionally bind the rear boot 230 to the rear binding 240 using rear straps 242. In certain scenarios, the snowboarder must ride the snowboard 210 without the rear boot 230 being bound to the rear binding 240. One such scenario comprises dismounting a chairlift, a conventionally challenging maneuver. However, when using the temporary binding apparatus 224, the snowboarder may temporarily bind the rear boot 230 to the snowboard 210 by causing the boot binding assembly 222 to be bound to the magnetic binding assembly 220, as described in greater detail below. The temporary binding apparatus 224 allows the snowboarder to quickly gain control of the snowboard 210 while exiting the chairlift, and defer a more time consuming step of strapping into their conventional binding system until after clearing the chairlift dismount area.

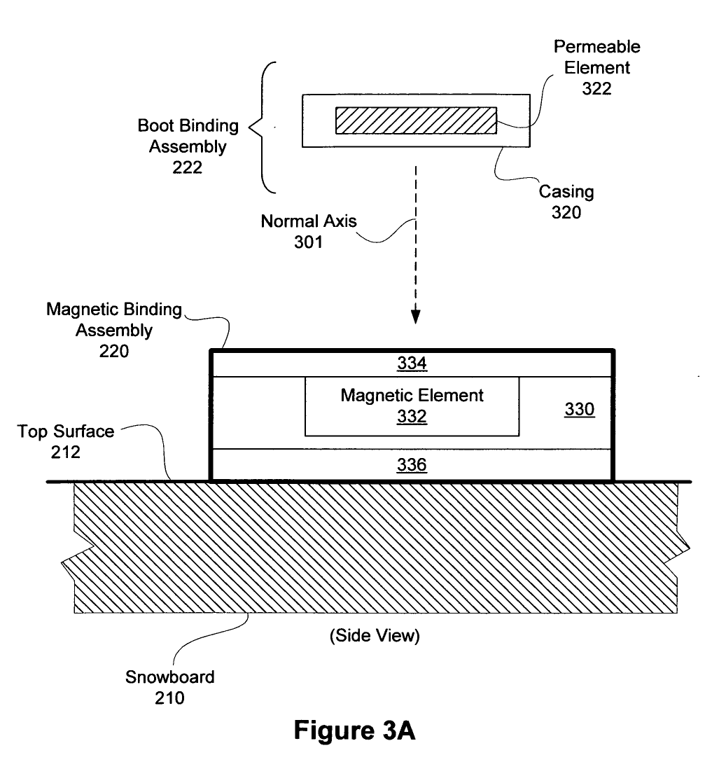

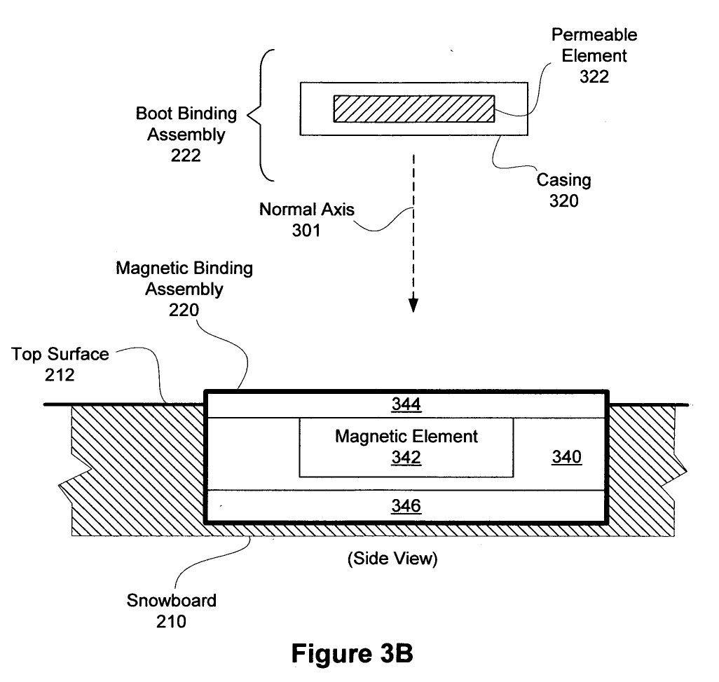

FIG. 3A is a detailed cross-section of the boot binding assembly 222 of FIG. 2A and the magnetic binding assembly 220 attached to the top surface 212 of a top side of the snowboard 210, according to one embodiment of the invention. The boot binding assembly 222 includes a permeable element 322, configured to include one or more discrete permeable components that exhibit a moderate to high degree of magnetic permeability. Specifically, a moderate degree of permeability is characterized herein as having a relative permeability (defined with respect to air) greater than five hundred: A high degree of permeability is characterized herein as having a relative permeability greater than five thousand. Each discrete permeable component should also exhibit low residual magnetism. Residual magnetism characterizes how much magnetic field a permeable article generates after being removed from a magnet. The permeable element 322 should be designed to minimize residual magnetism.

In one embodiment, the discrete permeable components are configured to form a pattern substantially encompassed by an outline of the shape of the rear boot 230 projected onto the top surface 212 of the snowboard 210. For example, the outline may be based on a shape of the rear boot sole 232.

The boot binding assembly 222 may also include a casing 320 configured to enclose at least part of the permeable element 322 and to provide mechanical structure for mounting the boot binding assembly 222 to the rear boot sole 232. The casing 320 may also provide mechanical structure for mounting, and holding in position, the one or more permeable components. The magnetic binding assembly 220 includes a magnetic element 332, and an attachment element 336. The attachment element 336 should be configured to attach the magnetic binding assembly 220 to the top surface 212 of the snowboard 210. The magnetic binding assembly 220 may also include a casing 330, configured to enclose at least part of the magnetic element 332. The magnetic binding assembly 220 may also include a surface element 334, configured to provide a protective barrier above the magnetic element 332.

In one embodiment, the magnetic element 332 comprises one or more magnets that are oriented with either a north magnetic pole or a south magnetic pole generally aligned along a normal axis 301 from the top surface of the magnetic binding assembly 220. The permeable element 332 may also be generally aligned along the normal axis 301 when coupled to the magnetic binding assembly 220. As the boot binding assembly 222 is brought into closer proximity with the magnetic binding assembly 220, a magnetic attractive force between the magnetic element 332 and the permeable element 322 increases. When the snowboarder maneuvers the rear boot 230 to step onto the magnetic binding assembly 220, the permeable element 322 within the boot binding assembly 222 is pulled, via the magnetic attractive force, to the magnetic element 332 within the magnetic binding assembly 220, thereby temporarily binding the rear boot 230 to the snowboard 210.

With a sufficiently strong magnetic attractive force, or “binding force,” between the magnetic element 332 and the permeable element 322, the rear boot 230 should remain sufficiently well bound to the snowboard 210 for the snowboarder to perform certain maneuvers, such as dismounting a chairlift and riding a short distance from a chairlift dismount location to a safe location away from dismount traffic. Depending on the size and weight of the snowboard 210 and riding style of the snowboarder, a binding force of two to twenty pounds may be sufficient to bind the rear boot 230 to the magnetic binding assembly 220 for the snowboarder to perform basic maneuvers. Binding force may be measured as a “pull force” needed to separate a rear boot 230 from the magnetic binding assembly 220. A binding force of one hundred pounds or more may be excessive in certain settings. When disengaging (unbinding) the rear boot 230 from the magnetic binding assembly 220, a binding force of one pound or less should be easily overcome by a snowboarder.

An inherent pull force is defined herein as a pull force measured with zero distance between a magnet and a sheet of ferromagnetic (permeable) material. Inherent pull force represents a maximum pull force for a given combination of magnet and permeable material. Because the pull force generated by the one or more magnets may be substantially diminished by unavoidable spatial separation from the permeable element, each one of the one or more magnets may need to exhibit a substantially higher inherent pull force than the two to twenty pounds required to bind the rear boot 230 to the magnetic binding assembly 220. For example, each one of the at least one magnets may need an inherent pull force of over fifty pounds for the pull force between the rear boot 230 and the magnetic binding assembly 220 to achieve at least five pounds.

Upon reaching the chairlift dismount location, the snowboarder may position the rear boot 230 over the magnetic binding assembly 220, allowing the boot binding assembly 222 to be pulled to the magnetic binding assembly 220, thereby temporarily binding the rear boot 230 to the snowboard 210. With the rear boot 230 temporarily bound to the snowboard 210, the snowboarder can better control their dismount ride until they have safely cleared the chairlift dismount location and arrived at an safe location away from the dismount area. After the snowboarder has cleared the chairlift dismount location and upon arriving at the safe location, the snowboarder may remove the rear boot 230 from the magnetic binding assembly 220 and robustly bind the rear boot 230 to the rear binding 240 for conventional riding on the snowboard 210.

Positioning the rear boot 230 over the magnetic binding assembly 220 should be easily accomplished by the snowboarder, even when preparing to exit a chairlift. Once the snowboarder has positioned the rear boot 230 in general proximity over the magnetic binding assembly 220, good alignment between the permeable element 322 and the magnetic element 342 should be achieved as a magnetic attractive binding force (or simply “binding force”) pulls the permeable element 322 and the magnetic element 342 together.

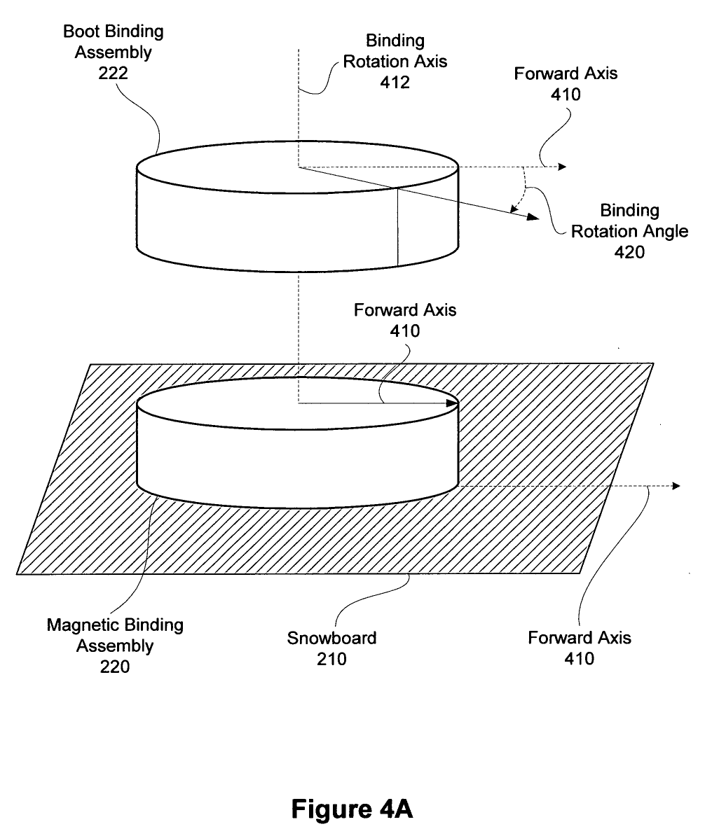

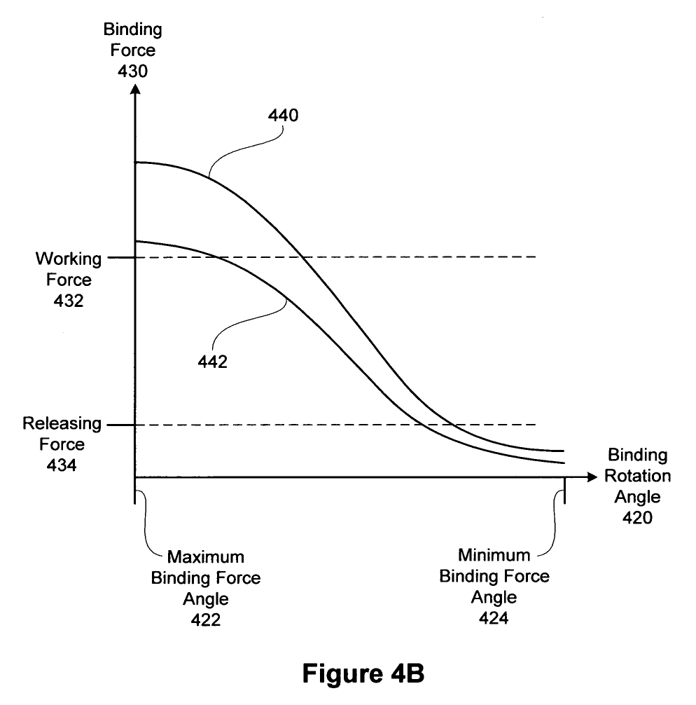

To unbind the rear boot 230 from the magnetic binding assembly 220, the snowboarder may execute a simple unbinding procedure that includes rotating the rear boot 230 along an axis substantially normal to the top surface 212, so as to misalign the permeable element 322 and the magnetic element 342. Persons skilled in the art will recognize that rotating the permeable element 322 and the magnetic element 342 into a misaligned position should require substantially less effort than directly and forcefully overcoming the binding force between the boot binding assembly 222 and the magnetic binding assembly 220. As shown in FIGS. 4A through 7D, the boot binding assembly 222 and magnetic binding assembly 220 are configured to develop a binding force that is a function of a binding rotation angle between the boot binding assembly 222 and the magnetic binding assembly 220.

In certain embodiments, the surface element 334 and casing 330 may comprise a single component. For example, surface element 334 and casing 330 may be manufactured from a single article of aluminum, polycarbonate, or any other material that substantially passes magnetic fields.

In one embodiment, the magnetic binding assembly 220 is configured as a modification to a conventional snowboard, and the boot binding assembly 222 is configured as a modification to a conventional rear boot. In one embodiment, the magnetic binding assembly 220 may be provided as a first modification kit. Similarly, the boot binding assembly 222 may be provided as a second modification kit. The first modification kit and second modification kit may be combined into a combined modification kit. An instance of the first modification kit enables users to modify a generic snowboard to include the magnetic binding assembly 220. An instance of the second kit enables user to modify a generic snowboard boot to include the binding assembly 220.

FIG. 3B is a detailed cross-section of the boot binding assembly 222 and the magnetic binding assembly 220 embedded within the snowboard 210, according to one embodiment of the invention. The boot binding assembly 222, magnetic binding assembly 220, and snowboard 210 are configured substantially identically to FIG. 3A, differing in that at least a portion of the magnetic binding assembly 220 is configured to be embedded below the top surface 212 of the top side of the snowboard 210, rather than being attached to the top surface 212. In one embodiment, the snowboard 210 is manufactured to include the magnetic binding assembly 220. In an alternative embodiment, the snowboard 210 is manufactured to include a cavity configured to accommodate the magnetic binding assembly 220. In these embodiments, the magnetic binding assembly 220 is coupled to the snowboard 210 at the top surface 212 and may also extend into the cavity below the surface. The magnetic binding assembly 220 may include a coupling means disposed below the top surface 212, for example in the cavity, and configured to robustly attach the magnetic binding assembly 220 to the snowboard 210.

FIG. 4A illustrates a binding rotation angle 420 between the boot binding assembly 222 of FIG. 2A and the magnetic binding assembly 220, according to one embodiment of the invention. A forward axis 410 forms a line of reference with respect to the snowboard 210 and generally corresponds to a forward line of motion for the snowboard. When the boot binding assembly 222 is coupled to the magnetic binding assembly 220, the binding rotation angle 420 indicates an angle of rotation between the boot binding assembly 222 and the magnetic binding assembly 220.

In one embodiment, the magnetic binding assembly 220 is robustly coupled to the snowboard 210, and the boot binding assembly 222 becomes engaged with the magnetic binding assembly 220 after the snowboarder positions the rear boot 230 in close proximity to the magnetic binding assembly 220, which is pulled to the boot binding assembly 222. When the boot binding assembly 222 is sufficiently close to the magnetic binding assembly 220, the magnetic element 332 within the magnetic binding assembly 220 pulls against the permeable element 322 within the boot binding assembly 222 until the two assemblies are bound together via a resulting binding force.

When bound to the magnetic binding assembly 220, the boot binding assembly 222 should be configured to rotate with respect to the magnetic binding assembly 220 about a binding rotation axis 412. The binding rotation axis 412 may be located anywhere on the magnetic binding assembly 220, according to a particular implementation. For example the binding rotation axis 412 may be positioned at a geometric centroid of the magnetic binding assembly 220.

FIG. 4B illustrates binding force 430 as a function of binding rotation angle 420, according to one embodiment of the invention. When the boot binding assembly 222 is positioned flush with the magnetic binding assembly 220, along the binding rotation axis 412, a resulting binding force 430 is developed that is a function of binding rotation angle 420. A working force 432 represents a binding force 430 that is at least sufficient to keep the boot binding assembly 222 bound to the magnetic binding assembly 220 while the snowboarder performs basic riding maneuvers, for example on a traverse from the chairlift dismount point to the attachment location. A releasing force 434 represents a binding force 430 small enough to allow the snowboarder to easily remove the boot binding assembly 222 from the magnetic binding assembly 220. In one embodiment, the working force 432 is at least two pounds and the releasing force 434 is less than one pound.

The magnetic binding assembly 220 and boot binding assembly 222 should be configured to develop at least a working force 432 when aligned at a maximum binding force angle 422, and to develop no more than a releasing force 434 when aligned to a minimum binding force angle 424. The binding force 430 may be represented as a force curve, which indicates binding force 430 over a range of binding rotation angles 420. In one configuration, force curve 440 represents a strong scenario, in which manufacturing tolerances related to the boot binding assembly 222 and magnetic binding assembly 220 favor a stronger binding force 430, and the boot binding assembly 222 and magnetic binding assembly 220 are relatively free of snow and debris. Importantly, the force curve 440 satisfies requirements for both at least a minimum working force 432 and at most a maximum allowable releasing force 434. In another configuration, manufacturing tolerances, snow, and debris may conspire to create a weak scenario that does not favor a strong binding force 430. In this configuration, the force curve 442 still satisfies requirements for both the minimum working force 432 and maximum allowable releasing force 434.

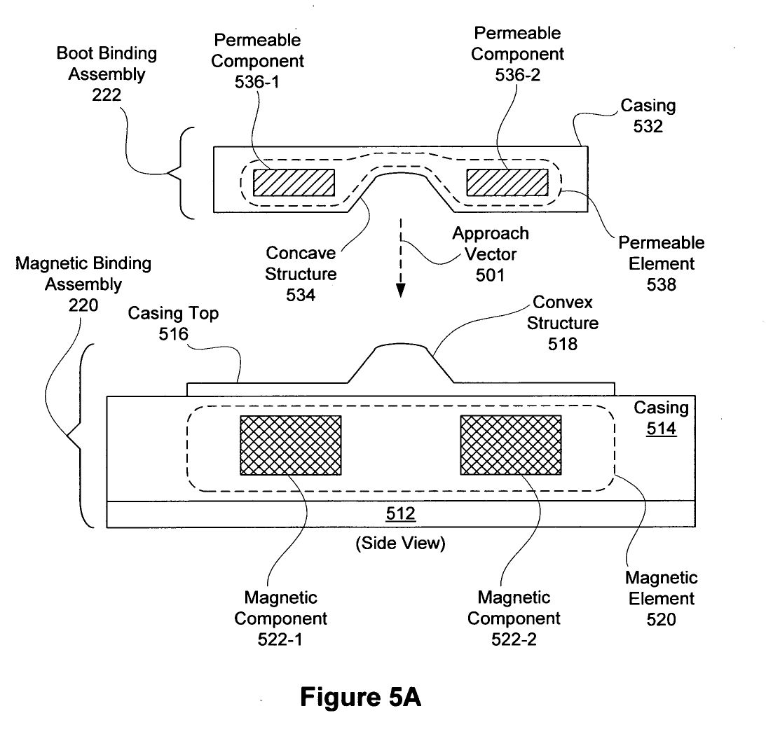

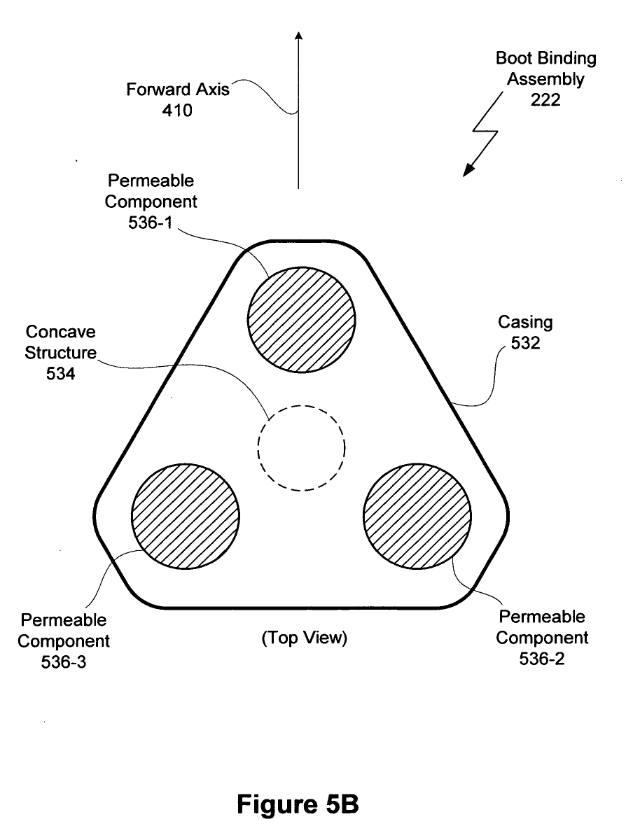

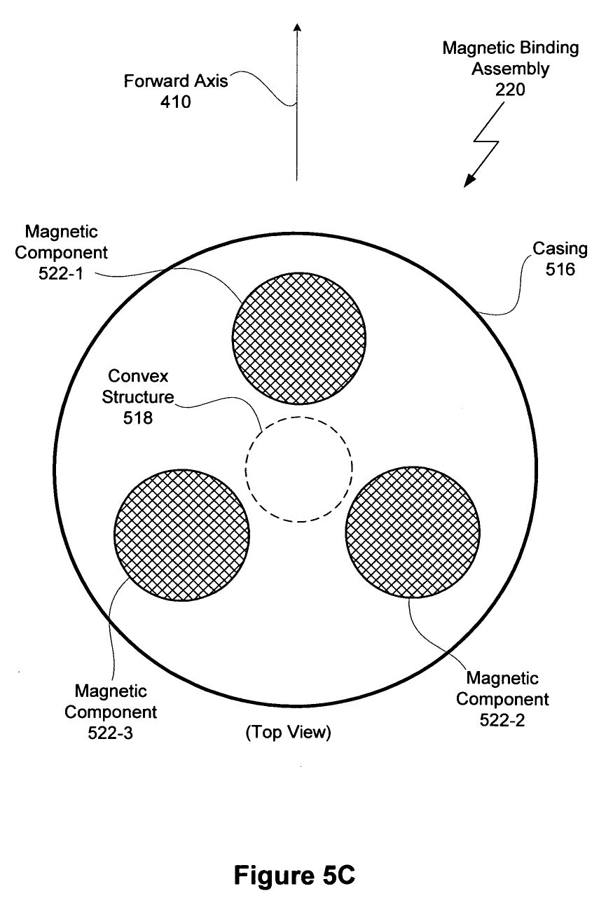

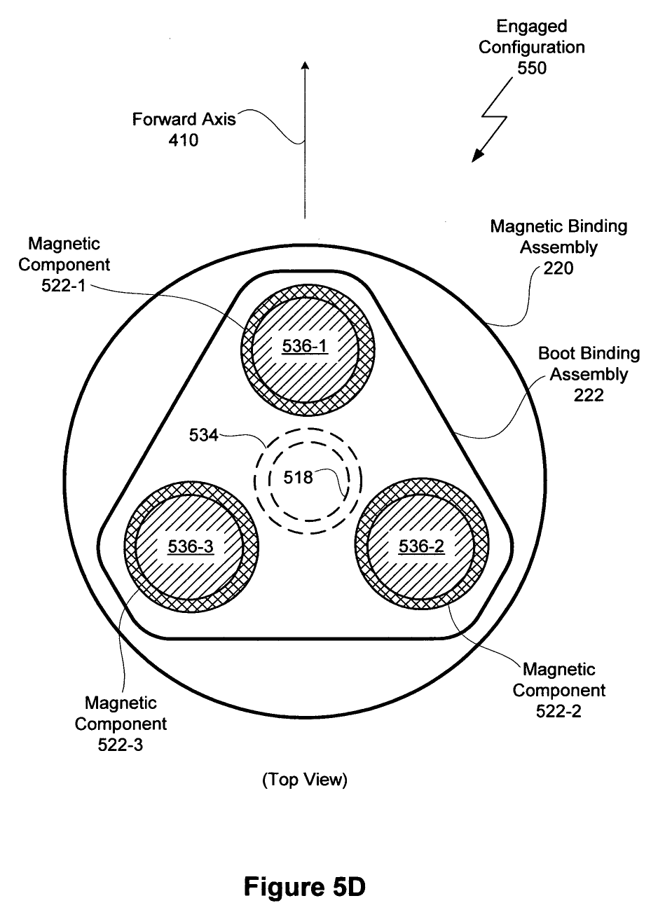

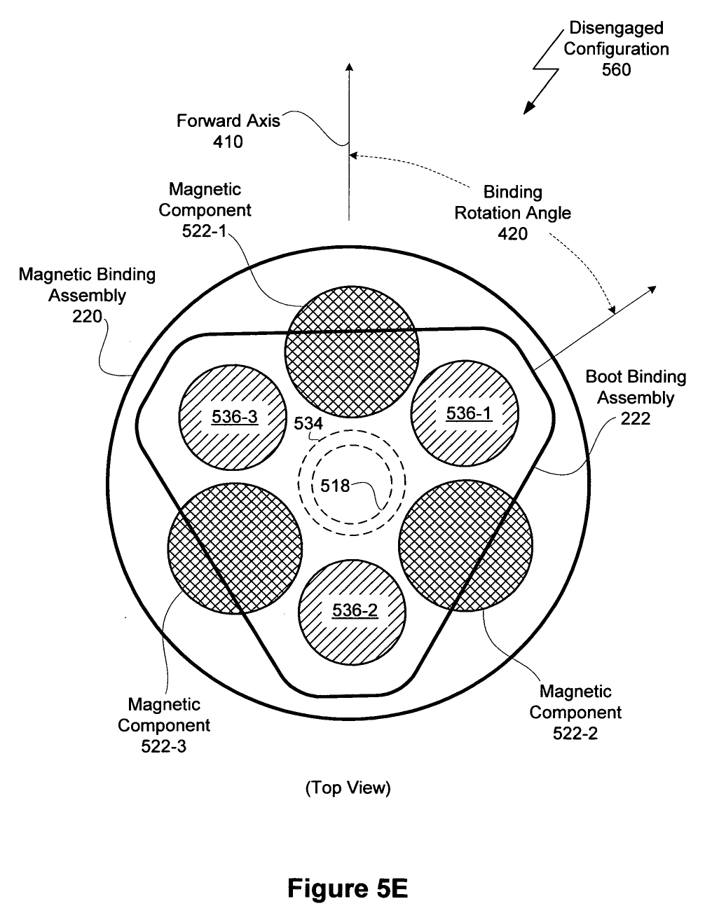

FIG. 5A is a cross-section of an exemplary magnetic binding assembly 220 and a matching boot binding assembly 222, according to one embodiment of the invention. The boot binding assembly 222 includes a permeable element 538, which should include one or more permeable components 536. The one or more permeable components 536 are constructed of a material that is attracted by magnetic fields, such as any ferromagnetic material. In a preferred embodiment, the one or more permeable components 536 are fabricated from a material that possesses a relatively high magnetic permeability and does not retain magnetization well (low residual magnetism). One type of material known in the art that has a relatively high permeability and relatively low residual magnetism is referred to as “soft iron.” Another such material is referred to in the art as “mu-metal.”

The boot binding assembly 222 should also include a casing 532 configured to include a concave structure 534. The casing 532 should be constructed from a material, such as polycarbonate or aluminum, which substantially allows a constant magnetic field to pass through the material. The concave structure 534 is configured to open downward with respect to the bottom of the rear boot 230. In an alternative embodiment, the rear boot sole 232 includes the concave structure 534.

The magnetic binding assembly 220 includes a magnetic element 520, which should include one or more magnetic components 522. Each of the one or more magnetic components 522 should comprise a relatively strong, permanent magnet. In one embodiment, each of the one or more magnetic components 522 comprises a neodymium magnet. Persons skilled in the art will recognize that any sufficiently strong permanent magnet may be employed as each of the one or more magnetic components 522. The magnetic binding assembly 220 may also include a casing 514 configured to provide mechanical structure for the magnetic element 520, and may hold the one or more magnetic components 522 in place. In one embodiment, each of the one or more magnetic components 522 is configured within the casing 514 to generally align with each of the one or more permeable components 536. For example, magnetic components 522-1 and 522-2 may be configured to align with permeable components 536-1 and 536-2, respectively.

The magnetic binding assembly 220 includes a convex structure 518. The magnetic binding assembly 220 may also include also include a casing top 516, which may serve as a protective barrier for the casing 514 and magnetic element 520. The convex structure 518 may be fabricated as part of the casing top 516. The convex structure 518 may comprise a section of a volume of revolution from an arbitrary curve, such as a parabola or an arc of a circle. The convex structure 518 should be configured to substantially fit into the concave structure 534 associated with the boot binding assembly 222. When the boot binding assembly 222 is brought into proximity with the magnetic binding assembly 220 along an appropriate approach vector 501, a magnetic force increasingly develops between each magnetic component 522 and each corresponding permeable component 536. The boot binding assembly 222 may then be pulled into contact and bind with the magnetic binding assembly 220, such that the convex structure 518 protrudes upward and into the concave structure 534, and each magnetic component 522 is aligned with a corresponding permeable component 536. This configuration is referred to herein as an engaged configuration. Importantly, a pivot means is formed by the convex structure 518 protruding into the concave structure 534, enabling the boot binding assembly 222 to readily rotate with respect to the magnetic binding assembly 220, about the convex structure 518.

To disengage the boot binding assembly 222 from the magnetic binding assembly 220, the boot binding assembly 222 may be rotated about the convex structure 518 until each permeable component 536 is generally unaligned with respect to any corresponding magnetic component 522. This configuration is referred to herein as a disengaged configuration. Persons skilled in the art will recognize that the pivot means allows a snowboarder to easily transition between the engaged position and the disengaged position by rotating the rear boot without forceful or abrupt movement. This is an important advantage in settings that favor stability and balance. Engaged and disengaged configurations are illustrated in greater detail in FIGS. 5B through 5E.

The magnetic binding assembly 220 should include an attachment element 512, configured to robustly couple the magnetic binding assembly 220 to the snowboard 210. In one embodiment, the attachment element 512 comprises an adhesive agent such as epoxy, epoxy film, glue, or adhesive sheet, which may serve to robustly affix the magnetic binding assembly 220 to the snowboard 210. In another embodiment, the attachment element 512 comprises a system of screws that may be coupled to the attachment element 512 and driven into the snowboard 210 to couple the magnetic binding assembly 220 to the snowboard 210. In yet another embodiment, the attachment element 512 comprises a system of anchors disposed within the snowboard 210 and coupled to the attachment element 512 to couple the magnetic binding assembly 220 to the snowboard 210.

FIG. 5B illustrates a top view of an exemplary boot binding assembly 222 with three permeable components 536, according to one embodiment of the invention. The boot binding assembly 222 should include permeable components 536-1 through 536-3 disposed about the concave structure 534. The casing 532 may be used to provide a structural support to maintain each permeable component 536 in each respective position. When the boot binding assembly 222 is bound to the magnetic binding assembly 220 (and therefore the snowboard 210), a forward axis 410 is established along a path from the rear binding 240 in the direction of the front binding 252. The forward axis 410 may be arbitrarily set with respect to the rotation of the boot binding assembly 222, but is generally fixed for a specific configuration of the boot binding assembly 222 and the magnetic binding assembly 220.

In one embodiment, the concave structure 534 is placed central to the geometry of the permeable components 536 (as shown). In alternative embodiments, the concave structure may be placed at an arbitrary offset with respect to the geometry of the permeable components 536. The permeable components 536 may be distributed using a substantially equal distance to each neighbor (as shown), or in an arbitrary pattern (not shown).

FIG. 5C illustrates a top view of an exemplary magnetic binding assembly 220 with three magnetic components 522, according to one embodiment of the invention. The three magnetic components 522 are organized in a pattern within casing 516 to correspond to the pattern of permeable components 536. As shown, the magnetic components may be organized about the convex structure 518. The convex structure 518 should be positioned to correspond to the location of the concave structure 534 when the boot binding assembly 222 and magnetic binding assembly 220 are bound together.

FIG. 5D illustrates the boot binding assembly 222 and the magnetic binding assembly 220 aligned in an engaged configuration 550, according to one embodiment of the invention. In this engaged configuration 550, each permeable component 536 is aligned with and attracted to each corresponding magnetic component 522. In this engaged configuration 550, the convex structure 518 protrudes into the concave structure 534 forming the pivot means, and the permeable components 536 and magnetic components 522 should be configured to develop a binding force 430 with a magnitude of at least the working force 432.

FIG. 5E illustrates the boot binding assembly 222 and the magnetic binding assembly 220 rotated in a disengaged configuration 560, according to one embodiment of the invention. The disengaged configuration 560 is achieved when the boot binding assembly 222 is rotated about the concave structure 534, as measured by binding rotation angle 420, so that each permeable component 536 is rotated away from each corresponding magnetic component 522. As a result of such a rotation, the binding force 430 is reduced, which allows the snowboarder to easily disengage the rear boot 230 from the snowboard 210 without a need for a mechanical pulling or prying device, and without the snowboarder needing to perform a forceful motion.

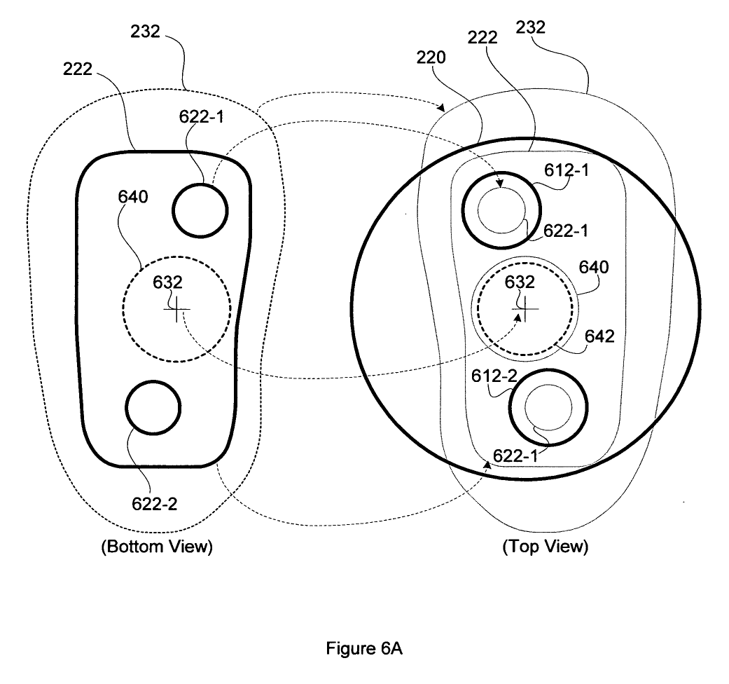

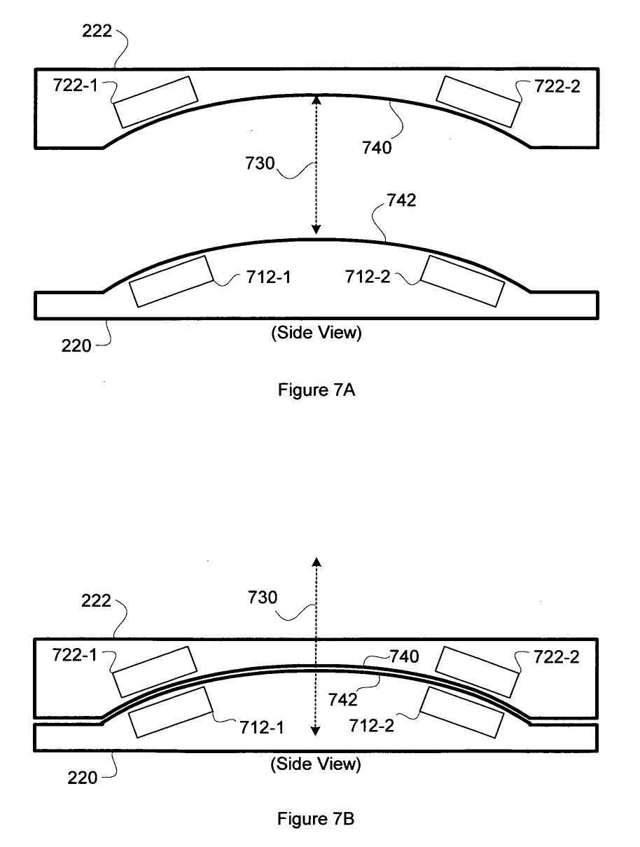

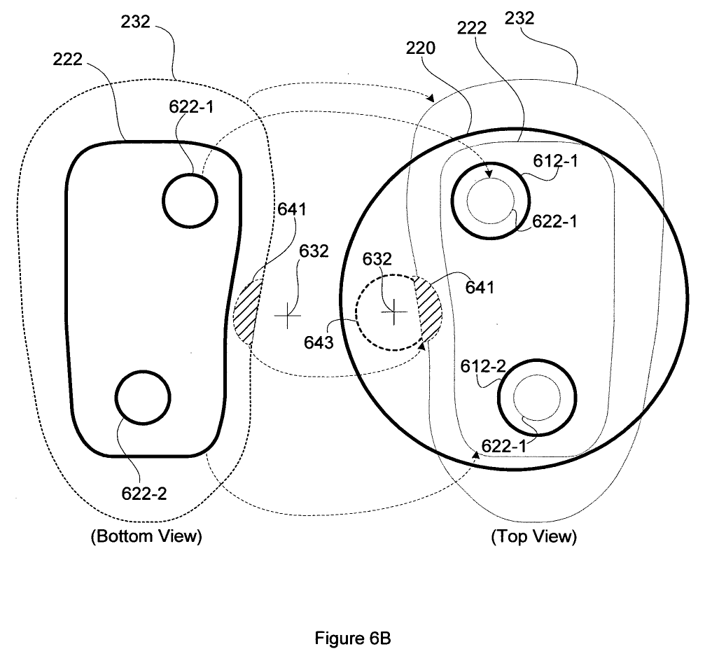

FIG. 6A illustrates the boot binding assembly 222 of FIG. 2 comprising two permeable components 622 and the magnetic binding assembly 220 comprising two matching magnetic components 612, according to one embodiment of the invention. The permeable components 622 comprise a permeable element, such as permeable element 322 of FIG. 3A. The magnetic components 612 comprise a magnetic element, such as magnetic element 332. In one embodiment, the boot binding assembly 222 is coupled to the rear boot sole 232 to augment a conventional snowboard boot (not shown) after the conventional snowboard boot is manufactured. Alternatively, the boot binding assembly 222 is coupled to the rear boot sole 232 as part of a manufacturing process to produce a snowboard boot (not shown) that integrates the boot binding assembly 222.

In one embodiment, the boot binding assembly 222 includes two permeable components 622-1 and 622-2, disposed about a concave structure 640. The magnetic binding assembly 220 includes two magnetic components 612-1 and 612-2, disposed about a convex structure 642, configured to protrude into the concave structure 640 and form a pivot means. A rotation axis 632 indicates an approximate binding rotation axis, such as binding rotation axis 412, about which the boot binding assembly 222 may rotate with respect to the magnetic binding assembly 220. When the boot binding assembly 222 is bound to the magnetic binding assembly, the concave structure 640 is approximately aligned with the convex structure 642, and magnetic components 612-1 and 612-2 are aligned with permeable components 622-1 and 622-2, respectively.

A user (e.g., a snowboarder) may bind the boot binding assembly 222 to the magnetic binding assembly 220 by bringing the boot binding assembly 222 into proximity of the magnetic binding assembly 220 so that the permeable components 622 are pulled together with respective magnetic components 612. For example, the user may bring their rear boot 230, configured to include the boot binding assembly 222, into close proximity with the magnetic binding assembly 220, which is coupled to the snowboard 210. This action binds the rear boot 230 to the snowboard 210 in the engaged configuration, as defined previously herein. The user may rotate the rear boot 230, and therefore, the boot binding assembly 222 with respect to the magnetic binding assembly 220 to disengage and remove the boot binding assembly 222 from the magnetic binding assembly 220, thereby removing the rear boot 230 from the snowboard 210. Importantly, the user may transition between the engaged configuration and disengaged configuration easily by rotating the rear boot 230 with respect to the snowboard 210.

In an alternative embodiment, illustrated below in FIG. 6B, the convex structure is located adjacent to the rear boot sole 232, and is configured to facilitate rotation between the boot binding assembly 222 and the magnetic binding assembly 220. In this embodiment, the user may push laterally against the convex structure with a side edge of the rear boot sole 232 in order to rotate the rear boot and disengage the boot binding assembly 222 from the magnetic binding assembly 220. In this alternative embodiment, a concave structure may be optionally fabricated in the side edge of the rear boot sole 232 to facilitate a rotation.

FIG. 6B illustrates the boot binding assembly 222 of FIG. 2 comprising two permeable components 622 and the magnetic binding assembly 220 comprising two matching magnetic components 612, according to an alternative embodiment of the invention. The magnetic components 612 comprise a magnetic element, such as magnetic element 332. In one embodiment, the boot binding assembly 222 is attached to the rear boot sole 232 to augment a conventional snowboard boot (not shown) after the conventional snowboard boot is manufactured. Alternatively, the boot binding assembly 222 is attached to the rear boot sole 232 as part of a manufacturing process to produce a snowboard boot (not shown) that integrates the boot binding assembly 222. When the boot binding assembly 222 is bound to the magnetic binding assembly 220, the magnetic components 612-1 and 612-2 are generally aligned with permeable components 622-1 and 622-2, respectively.

In one embodiment, the boot binding assembly 222 includes two permeable components 622-1 and 622-2. The boot binding assembly 222 may include a concave structure 641, or the concave structure 641 may be fabricated as part of the rear boot sole 232, as shown. The magnetic binding assembly 220 includes two magnetic components 612-1 and 612-2. The magnetic binding assembly 220 should also include a convex structure 643, configured to abut at least a portion of the rear boot sole 232 to form a pivot means when the magnetic binding assembly 220 and boot binding assembly 222 are in the engaged configuration. In one embodiment, the concave structure 641 and convex structure 643 form the pivot means. In an alternative embodiment, the convex structure 643 and a side edge of the rear boot sole 232 form the pivot means. A rotation axis 632 indicates an approximate binding rotation axis, such as binding rotation axis 412, for the pivot means.

A user (e.g., a snowboarder) may bind the boot binding assembly 222 to the magnetic binding assembly 220 by bringing the boot binding assembly 222 into proximity of the magnetic binding assembly 220 so that the permeable components 622 are pulled together with respective magnetic components 612. For example, the user may bring their rear boot 230, configured to include the boot binding assembly 222, into close proximity with the magnetic binding assembly 220, which is attached to the snowboard 210. This action binds the rear boot 230 to the snowboard 210 in the engaged configuration, as defined in FIGS. 4A and 4B. The user may rotate the rear boot 230, and therefore, the boot binding assembly 222 with respect to the magnetic binding assembly 220 to disengage and detach the boot binding assembly 222 from the magnetic binding assembly 220, thereby detaching the rear boot 230 from the snowboard 210. Importantly, the user may transition between the engaged configuration and disengaged configuration easily by rotating the rear boot 230 with respect to the snowboard 210.

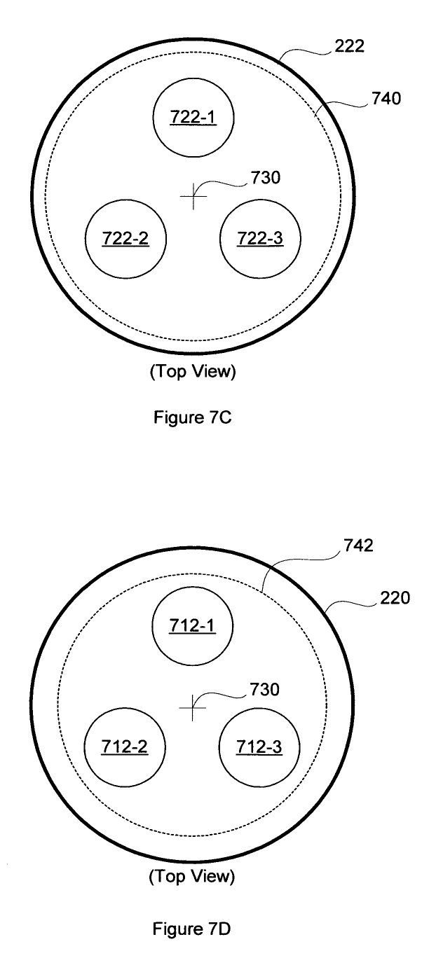

FIG. 7A illustrate a side view of a concave structure 740 configured to encircle one or more permeable components 722 and a convex structure 742 configured to encircle one or more magnetic components 712 in the disengaged configuration, according to one embodiment of the invention. The one or more permeable components 722 comprise a permeable element, such as permeable element 322 of FIG. 3A. The one or more magnetic components 712 comprise a magnetic element, such as magnetic component 332. The concave structure 740 may be incorporated into boot binding assembly 222 of FIG. 2. The convex structure 742 may be incorporated into magnetic binding assembly 220.

When the one or more permeable components 722 within the boot binding assembly 222 are brought into proximity with the one or more magnetic components 712 within the magnetic binding assembly 220, a binding force is developed that should be sufficient to bind the two assemblies together with at least working force 432, as defined in FIGS. 4A and 4B. The concave structure 740 is configured to fit onto the convex structure 742, enabling the two assemblies to be fit closely together and to form a pivot means. The pivot means is configured to allow the two assemblies to rotate about a rotation axis 730, thereby allowing a user (snowboarder) to easily transition the two assemblies between the engaged configuration and the disengaged configuration, as defined previously.

In one embodiment, the convex structure 742 comprises a spherical section. In alternative embodiments, the convex structure 742 comprises a section of a volume formed by a paraboloid. In other alternative embodiments, the convex structure 742 comprises a section of a volume formed from a revolution of an arbitrary curve. In one embodiment, the concave structure 740 is substantially a geometric inverse of the convex structure 742, so that the convex structure 742 may protrude into the concave structure 740, forming a close fit between the two structures. In alternative embodiments, the geometry of the convex structure 742 and the geometry of the concave structure 740 may depart from each other to some degree, for example to incorporate grooves, bumps, or other surface features on either the convex structure 742 or the concave structure 740.

FIG. 7B illustrate a side view of a concave structure 740 configured to encircle one or more permeable components 722 and a convex structure 742 configured to encircle one or more magnetic components 712 in the engaged configuration, according to one embodiment of the invention.

FIG. 7C illustrates a top view of the concave structure 740, configured to encircle the one or more permeable components 722, according to one embodiment of the invention. In this example, three permeable components 722 are shown within the boot binding assembly 222, but an arbitrary number of permeable components may be used. In one embodiment, the diameter of the concave structure 740 is approximately the width of an associated rear boot 230. In alternative embodiments the diameter of the concave structure 740 is less than the width of the associated rear boot 230.

FIG. 7D illustrates a top view of the convex structure 742, configured to encircle the one or more magnetic components 712, according to one embodiment of the invention. Each of the one or more magnetic components 712 should be located within the magnetic binding assembly 220 in a position that matches a corresponding permeable component 722 and generally contributes to increasing the binding force when the boot binding assembly 222 and magnetic binding assembly 220 are in the engaged configuration.

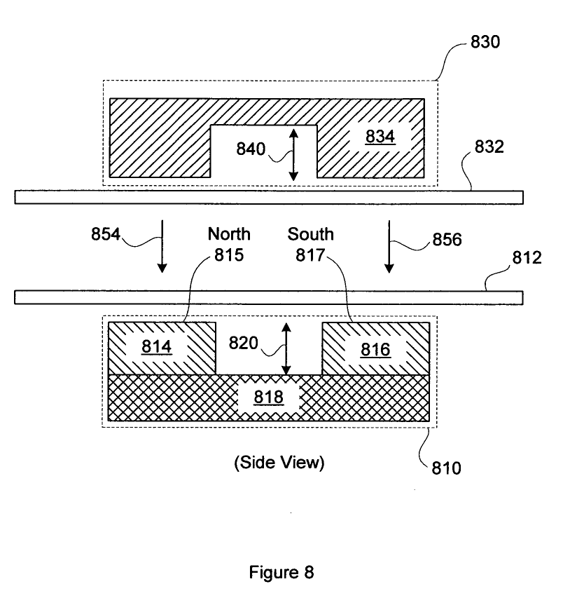

FIG. 8 illustrates a side view of magnetic component 810 configured to bind to a permeable component 830, according to one embodiment of the invention. The magnetic component 810 may comprise two magnets 814, 816, and a flux guide 818. Magnet 814 is configured to present a north pole 815 to a first side of permeable component 830 and magnet 816 is configured to present a south pole 817 to a second side of permeable component 830. Flux guide 818 is configured to couple the south pole of magnet 814 with the north pole of magnet 816 by concentrating magnetic flux within the volume of the flux guide 818. The flux guide 818 may be constructed of magnetically permeable material such as soft iron or mu-metal, with a moderate (above five) to high (above five thousand) relative permeability. A gap 820 specifies a thickness value, as shown. In one embodiment, the gap 820 is substantially identical to a thickness for each magnet 814, 816. In an alternative embodiment, the gap 820 is larger than the thickness of each magnet 814, 816. In other alternative embodiments, the magnetic component 810 may comprise one magnet manufactured as a single article that presents the north pole 815 and south pole 817 to the permeable component 830, and includes a gap 820 of greater than zero. A protective barrier 812, such as surface element 334 of FIG. 3A, is configured to protect the magnetic component 810 from physical damage, such as scratching, as well as chemical damage from certain agents.

The permeable component 830 may comprise one or more structures of magnetically permeable material, such as soft iron or mu-metal. In one embodiment, the permeable component 830 includes one block 834 of magnetically permeable material. A gap 840 specifies a region of material, such as air, aluminum, or polycarbonate, with a significantly lower magnetic permeability than the 834. A protective bather 832, such as that provided by casing 320, is configured to protect the permeable component 830 from physical damage, such as scratching, as well as chemical damage from certain agents. When permeable component 830 is brought into proximity of magnetic component 810, forces 854 and 856 develop between the permeable component 830 and the magnetic component 810. The forces 854 and 856 force permeable component 830 and magnetic component 810 together.

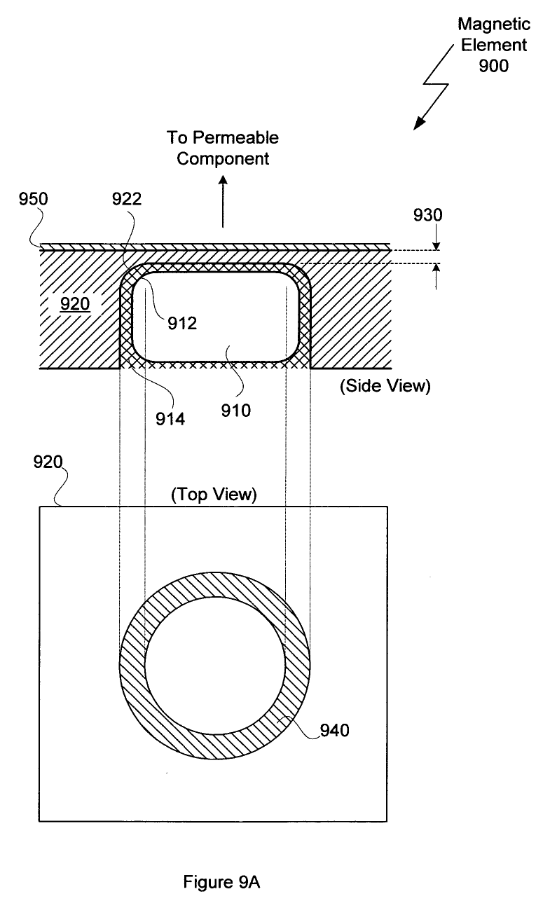

FIG. 9A illustrates a magnetic element 900 configured to include a magnetic component 910 having a beveled edge 912 and a casing 920 having a matching beveled edge 922, according to one embodiment of the invention. The magnetic element 900 may operate, for example, as magnetic element 332 of FIG. 3A, and may be incorporated into magnetic binding assembly 220.

Persons skilled in the art will recognize that many types of permanent magnets that are good candidates to function as magnetic component 910 are fragile with respect to scratches and other forms of mechanical damage. Damaging such magnets can lead to catastrophic structural failure of the magnet. To avoid certain types of damage, the magnetic component 910 should be shielded from mechanical damage such as impacts and scratches, and chemical damage such as corrosion. These forms of damage are very likely in a typical snowboarding environment. In one embodiment, a protective barrier 950 may serve as surface element 334 of FIG. 3A, protecting the magnetic component 910 from damage. The protective barrier 950 may be affixed to casing 920 or fabricated as a part of casing 920. The protective barrier 950 may be attached by a user after the magnetic element 900 is manufactured. The protective barrier 950 may also be attached as part of a manufacturing process for fabricating the magnetic element 900. The protective barrier 950 may include decorative markings, identifying markings, or any combination thereof. In one embodiment, thickness 930 is reduced to zero, exposing magnetic component 910 to the protective barrier 950.

In certain circumstances, the magnetic component 910 may apply a substantial binding force against the casing 920, resulting in stress, which can lead to structural failure of the casing 920 or the magnetic component 910. To reduce the likelihood of these types of structural failure, a force distribution means may be employed to distribute forces that develop between the magnetic component 910 and the casing 920. In one embodiment, beveled region 940 along the beveled edge 912 provides a force distribution means, which reduces localized stress associated with the binding force, and therefore reduces potential for structural failure. Because magnetic force diminishes quickly as a function of distance between a magnet and a permeable material, thickness 930 may have a significant impact on an overall binding force developed by the magnetic component 910 and an associated permeable component. Thickness 930 should, therefore, be minimized to the extent structural integrity of casing 920 is adequately preserved. Beveled edges 912 and 922 form the beveled region 940. In one embodiment, the beveled region 940 distributes the binding force asserted on casing 920 by magnetic component 910, thereby reducing localized stress and improving structural integrity of the casing 920.

The magnetic component 910 may be mounted in a cavity fabricated within the casing 920 and held in place by a filler material 914. The filler material 914 may comprise, a solid, a layered material, gel, adhesive, glue, epoxy, powder, or any other material configured to hold the magnetic component 910 in place. The filler material 914 should exhibit a property of distributing force and mechanical shocks developed between the casing 920 and the magnetic component 910.

FIG. 9B illustrates a magnetic element 901 comprising a magnetic component 910 and a flux guide 960, according to one embodiment of the invention. The magnetic element 901 may serve as magnetic element 332 of FIG. 3A, and may be incorporated into magnetic binding assembly 220. The flux guide 960 is disposed between a permeable element (not shown), such as permeable element 322, and the magnetic component 910. The flux gate 960 and magnetic component 910 should both be mounted in one or more cavities fabricated in casing 920. The flux guide 960 should be fabricated from a highly permeable material, such as mu-metal or soft iron. A spacer 915 of thickness 932 may be disposed between the flux guide 960 and the magnetic component 910. The spacer 915 is configured to absorb and disperse mechanical shocks developed between the flux guide 960 and the magnetic component 910. The spacer 915 may be fabricated from an adhesive, gel, glue, epoxy, plastic, paper, wax, powder, metal, or any other technically feasible material. In one embodiment, the spacer 915 is fabricated as part of the casing 920. A filler material 914 may be included to fill air gaps between the casing 920 and the magnetic component 910. The filler material 914 may also provide force distribution and shock-dispersal between the casing 920 and the magnetic component 910. A protective barrier 950 may be configured to protect the casing 920 from mechanical, chemical, or other forms of damage. The protective barrier 950 may also be configured to protect the flux guide 960 from damage.

In one embodiment, the flux guide 960 is exposed through the protective barrier 950, minimizing spacing between the permeable element and the flux guide 960. The spacer 915 is configured to be relatively thin (e.g., less than one millimeter in thickness) to reduce distance between the magnetic component 910 and the flux guide 960. In this embodiment, the flux guide 960 is fabricated from a mechanically robust material with high permeability, such as soft iron or mu-metal. The flux guide 960 transmits the magnetic flux developed by magnetic component 910 to the top surface 951 of the magnetic element 901, without exposing the mechanically fragile magnetic component 910 to potential damage from a relatively hostile environment, commonly encountered in practical snowboarding settings. In this configuration, a relatively small (less than one millimeter) effective distance between the magnetic component 910 and a permeable component, such as permeable component 536 of FIG. 5A, may be achieved via the flux guide 960. Importantly, a smaller effective distance results in a stronger binding force between the magnetic component 910 and the permeable component. Without the flux guide 960, the effective distance is dictated by a protective barrier thickness, which may need to be thicker than the spacer 915 in practical applications. In one embodiment, the top surface of the flux guide 960 is smooth and represents an exposed surface of the flux guide 960. In an alternative embodiment, the top surface of the flux guide 960 includes bumps or spikes configured to poke through snow or ice buildup on the magnetic element 901. In an alternative embodiment, the protective barrier 950 is configured to cover the flux guide 960.

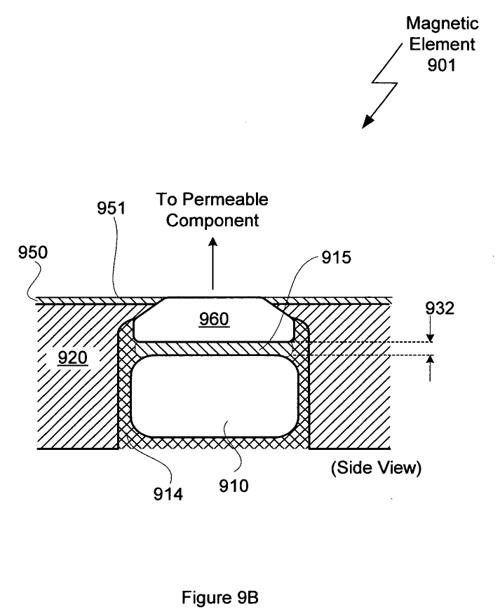

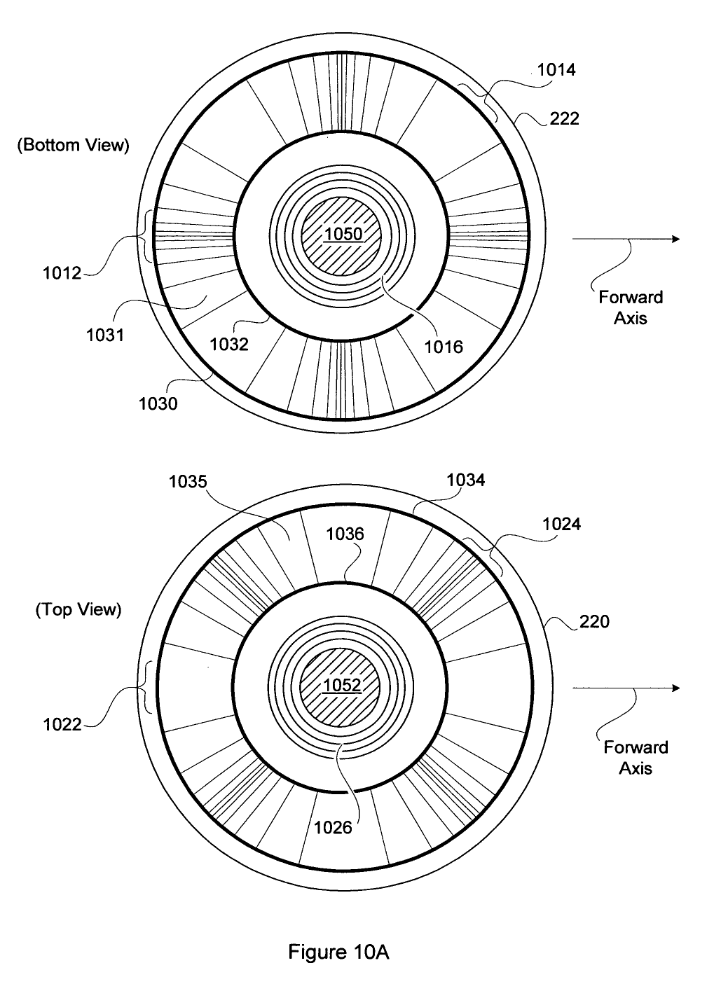

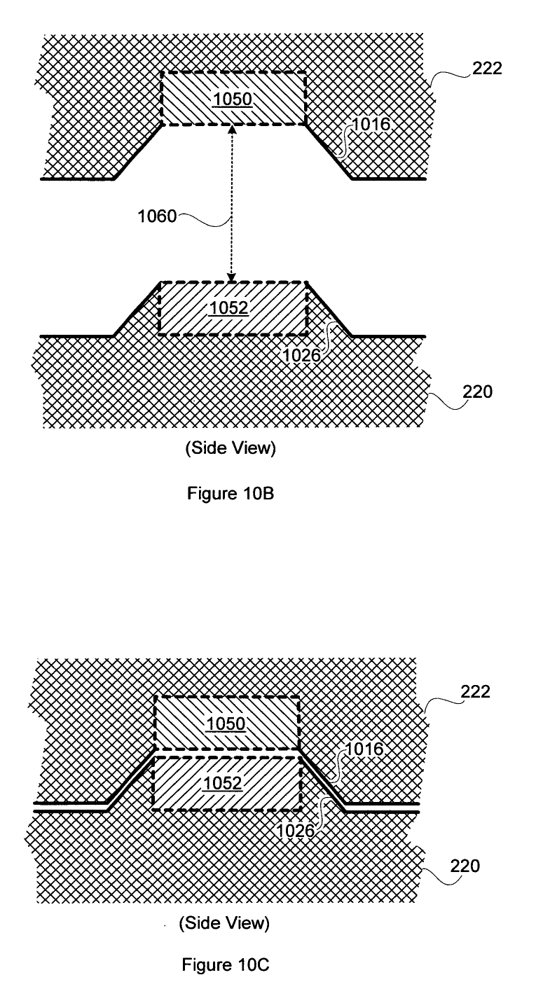

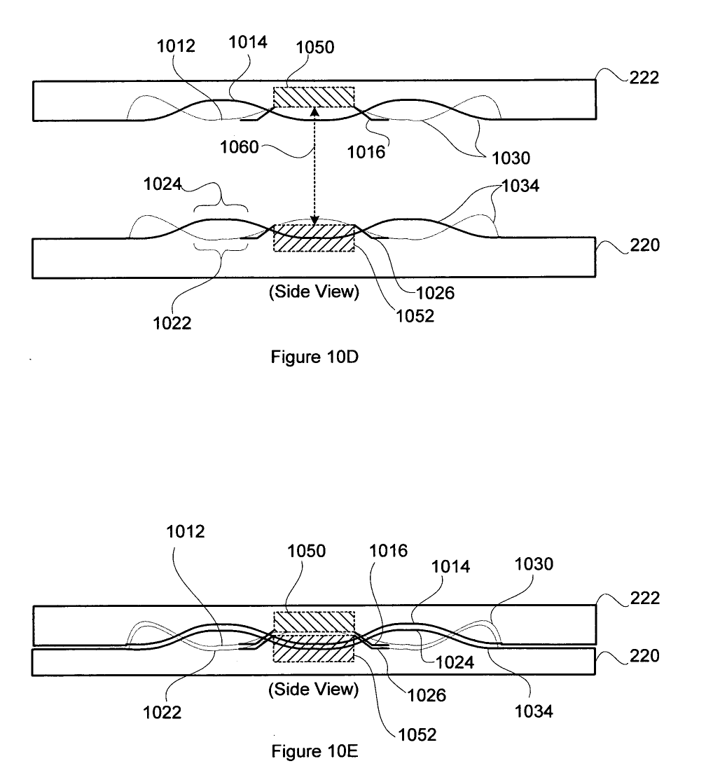

FIGS. 10A through 10E illustrate one embodiment of the invention, comprising boot binding assembly 222, magnetic binding assembly 220, and a pivot means that facilitates rotating the boot binding assembly 222 to an arbitrary rotation angle with respect to the magnetic binding assembly 220. A binding force between the boot binding assembly 222 and magnetic binding assembly 220 is developed as a function of the rotation angle.

FIG. 10A illustrates a bottom view of the boot binding assembly 222 and a corresponding top view of magnetic binding assembly 220, according to one embodiment of the invention. The boot binding assembly 222 comprises permeable element 1050, a concave structure 1016 (concave inward from page), and a first surface of varying height 1031 disposed between an inner perimeter 1032 and an outer perimeter 1030. The height of the first surface of varying height 1031 at a given angle around the outer perimeter 1030 is indicated herein by a density of radial lines connecting the inner perimeter 1032 and the outer perimeter 1030. Dense radial lines indicate increased height (increasing outward from page), as shown in region 1012. Sparse radial lines indicate decreased height, as shown in region 1014.

The magnetic binding assembly 220 comprises magnetic element 1052, a convex structure 1026 (concave outward from page), and a second surface of varying height 1035 disposed between inner perimeter 1036 and an outer perimeter 1034. The height of the second surface of varying height 1035 at a given angle about the outer perimeter 1034 is indicated herein by the density of radial lines connecting the inner perimeter 1036 and the outer perimeter 1034. Dense radial lines in region 1024 indicate increased height (increasing outward from page). Sparse radial lines in region 1022 indicate decreased height.

The first and second surfaces of varying height are configured to fit together in an engaged configuration, with a separation between the permeable element 1050 and magnetic element 1052 determined by the rotation angle. Because the binding force 430 of FIG. 4B between boot binding assembly 222 and magnetic binding assembly 220 is a function of separation between the permeable element 1050 and magnetic element 1052, the binding force is therefore a function of the rotation angle. In one embodiment, in the engaged configuration the first surface of varying height 1031 fits closely together with the second surface of varying height 1035, and each region along the surfaces of varying height 1031, 1035 should also fit closely together. For example, regions 1012 and 1014 fit closely together with regions 1022 and 1024, respectively. When the two surfaces of varying height 1031, 1035 are fit closely together, distance between the permeable element 1050 and magnetic element 1052 is reduced to a practical minimum. In one embodiment, magnetic element 1052 develops a binding force of at least the working force 432 of FIG. 4B with respect to permeable element 1050. When the boot binding assembly 222 is rotated with respect to the magnetic binding assembly 220, regions 1012 and 1024 are brought into alignment. Because both regions 1012 and 1024 are regions of increased height on their respective surface of varying height, the surfaces of varying height 1031 and 1035 are pushed apart, thereby pushing apart the permeable element 1050 and the magnetic element 1052. By increasing the distance between permeable element 1050 and magnetic element 1052 in this way, the binding force is reduced. In one embodiment, the binding force is reduced to no more than the releasing force 434.

FIG. 10B illustrates a side view of the concave structure 1016 and convex structure 1026 in the disengaged configuration, according to one embodiment of the invention. In one embodiment, the concave structure 1016 is fabricated as part of boot binding assembly 222. As shown, permeable element 1050 is mounted at the top of a cavity formed by concave structure 1016. In one embodiment, the convex structure 1026 is fabricated as part of the magnetic binding assembly 220. Magnetic element 1052 should be mounted atop the convex structure 1026. Rotation axis 1060 indicates an approximate rotation axis for the pivot means formed when convex structure 1026 protrudes into the concave structure 1016, for example, when the boot binding assembly 222 and magnetic binding assembly 220 are brought together.

Persons skilled in the art will recognize that the convex structure 1026 and concave structure 1016 will self-align when the boot binding assembly 222 is brought into close and nearly aligned proximity with the magnetic binding assembly 220 prior to the boot binding assembly 222 fully engaging the magnetic binding assembly 220. Therefore, the snowboarder does not need to precisely position their rear boot 230 over the magnetic binding assembly in order to prepare to configure the boot binding assembly 222 and the magnetic binding assembly 220 in the engaged configuration. Importantly, the snowboarder can easily engage the boot binding assembly 222 with the magnetic binding assembly 220 as they dismount the chairlift by stepping onto the magnetic binding assembly 220 with their rear boot 230. The placement of the rear boot 230 does not need to be precise because the convex structure 1026 and concave structure 1016 will self-align as the convex structure 1026 protrudes into the concave structure 1016 and the boot binding assembly 222 engages with the magnetic binding assembly 220.

FIG. 10C illustrates a side view of the concave structure 1016 and convex structure 1026 in the engaged configuration, according to one embodiment of the invention. As shown, the convex structure 1026 protrudes into the concave structure 1016, positioning the permeable element 1050 in close or touching proximity to the magnetic element 1052, thereby allowing the magnetic element 1052 to develop a binding force with respect to the permeable element 1050. This configuration of the permeable element 1050 and magnetic element 1052 corresponds to the engaged configuration for the boot binding assembly 222 and magnetic binding assembly 220. In one embodiment, the binding force developed between the magnetic element 1052 and permeable element 1050 is equal to or greater in magnitude than working force 432 of FIG. 4B.

FIG. 10D illustrates a side view of the boot binding assembly 222 and magnetic binding assembly 220 in the disengaged configuration, according to one embodiment of the present invention. Outer perimeter 1030 depicts a side view of the first surface of varying height 1031, not explicitly shown. Outer perimeter 1034 depicts a side view of the second surface of varying height 1035, not explicitly shown. As shown, region 1024 is shaped to fit into region 1014. Similarly, region 1012 is shaped to fit into region 1022. Persons skilled in the art will recognize that a plurality of specific shapes may be employed as the surfaces of varying height 1031, 1035.

In alternative embodiments, the first surface of varying height 1031 departs in geometry from the second surface of varying height 1035. For example, the first surface of varying height 1031 may include only a narrow bump or ellipsoid section for elevated region 1012, with the remaining portions of the first surface of varying height 1031 configured to a minimal height, such as region 1014 in FIG. 10A. In such embodiments, rotational friction is reduced by reducing contact area and contact angles between the first surface of varying height 1031 and the second surface of varying height 1035. As a result, less effort should be needed to rotate the boot binding assembly 222 with respect to the magnetic binding assembly 220.

FIG. 10E illustrates a side view of the boot binding assembly 222 and magnetic binding assembly 220 in the engaged configuration, according to one embodiment the present invention. As shown, outer perimeter 1030 fits closely together with outer perimeter 1034, depicting a corresponding close fit between the first surface of varying height 1031 and the second surface of varying height 1035. When the boot binding assembly 222 is rotated with respect to the magnetic binding assembly 220, the first surface of varying height 1031 slides against the second surface of varying height 1035, lifting the boot binding assembly 222 away from the magnetic binding assembly 220. Again, the first surface of varying height 1031 may depart in geometry from the second surface of varying height 1035 in certain alternative embodiments.

In one embodiment, a snowboard binding kit comprising an instance of the magnetic binding assembly 220 may be configured to facilitate augmenting a generic sports board, such as a snowboard, to include the magnetic binding assembly 220. In an alternative embodiment, a boot binding kit comprising an instance of the boot binding assembly 222 may be configured to facilitate augmenting or modify a generic sports boot, such as a generic snowboard boot, to include the boot binding assembly 222.

In summary, a temporary binding for a sports board, such as a snowboard, is disclosed herein. In one embodiment, a boot binding assembly coupled to a sports boot, such as a snowboard boot, is configured to engage with a magnetic binding assembly coupled to the sports board. When the sports boot is rotated with respect to the sports board, the magnetic binding assembly and boot binding assembly disengage and a user may easily remove the sports boot from the sports board. One advantage of the invention is that a user may readily bind the sports boot to the sports board and achieve greater riding control of the sports board during moments when the user's rear boot is otherwise not bound to the sports board. One such moment is during dismount from a chairlift. Alternative embodiments include any technically feasible binding technique between an apparatus coupled to a sports boot and an apparatus coupled to a sports board, wherein rotating the sports boot with respect to the sports board disengages the sports boot from the sports board.

While the forgoing is directed to embodiments of the present invention, other and further embodiments of the invention may be devised without departing from the basic scope thereof, and the scope thereof is determined by the claims that follow.

I claim:

1. A binding apparatus for a sports board, the apparatus comprising:
a boot assembly including a permeable element, wherein the boot assembly is configured to be coupled to an underside of a boot;
a magnetic assembly including a magnetic element, wherein the magnetic assembly is configured to be coupled to a top surface of a snowboard; and
a pivot means for rotating the boot assembly with respect to the magnetic assembly, the pivot means comprising a convex structure disposed on the magnetic assembly, wherein the convex structure is configured to protrude upward from the magnetic assembly relative to the top surface;
wherein a binding force is developed between the magnetic element and the permeable element, and wherein a strength of the binding force is a function of a rotation angle between the boot assembly and the magnetic assembly.

2. The apparatus of claim 1, wherein the boot assembly includes a concave structure configured to substantially encompass the convex structure.

3. The apparatus of claim 1, wherein a first binding force is developed for a first rotation angle, and a second binding force that is smaller than the first binding force is developed for a second rotation angle.

4. The apparatus of claim 3, wherein the first binding force is at least two pounds, and the second binding force is at most one pound.

5. The apparatus of claim 3, wherein the sports board is a snowboard.

6. The apparatus of claim 3, wherein the permeable element comprises one or more permeable components configured to form a first pattern enclosed by an outline of the boot.

7. The apparatus of claim 6, wherein the one or more permeable components are disposed within a first casing.

8. The apparatus of claim 6, wherein each of the one or more permeable components is fabricated from a magnetically permeable material having a relative permeability of at least five hundred.

9. The apparatus of claim 6, wherein the magnetic element comprises one or more magnetic components disposed within a second casing.

10. The apparatus of claim 9, wherein each of the one or more magnetic components is configured to form a second pattern based on the first pattern.

11. The apparatus of claim 9, wherein each of the one or more magnetic components generates an inherent pull force of at least fifty pounds.

12. The apparatus of claim 9, wherein at least one of the one or more magnetic components comprises a neodymium magnet.

13. The apparatus of claim 1, wherein the magnetic element comprises a magnetic component having a beveled edge, and wherein the magnetic component is disposed in a cavity fabricated to include a substantially matching beveled edge.

14. The apparatus of claim 13, wherein the magnetic element further comprises a protective barrier configured to shield the magnetic component from environmental damage.

15. The apparatus of claim 1, wherein the magnetic element comprises a flux guide disposed between a magnetic component and a top surface of the magnetic element.

16. The apparatus of claim 15, wherein the magnetic element further comprises a spacer disposed between the magnetic component and the flux guide.

17. A snowboard binding kit, comprising:
a magnetic assembly including a magnetic element, wherein the magnetic assembly is configured to be coupled to a top surface of a snowboard; and
a convex structure disposed on the magnetic assembly, wherein the convex structure is configured to protrude upward from the magnetic assembly relative to the top surface;

18. The snowboard binding kit of claim 17, further comprising:
a boot assembly including a permeable element and a concave structure configured to substantially encompass the convex structure, wherein the boot assembly is configured to be coupled to an underside of the boot; and
a pivot means for rotating the boot assembly with respect to the magnetic assembly, the pivot means comprising the convex structure and the concave structure;
wherein a binding force is developed between the magnetic element and the permeable element, and wherein a strength of the binding force is a function of a rotation angle between the boot assembly and the magnetic assembly;

19. The snowboard binding kit of claim 18, wherein a first binding force is developed for a first rotation angle, and a second binding force that is smaller than the first binding force is developed for a second rotation angle.

20. A sports apparatus, comprising:
a snowboard comprising a top surface, a bottom surface, a front end, and a back end,
a front binding coupled to the top surface and disposed closer to the front end relative to the back end;
a rear binding coupled to the top surface and disposed closer to the back end relative to the front end;
a boot assembly coupled to an underside of a sports boot; and
a binding coupled to the top surface and disposed between the front binding and the rear binding along the top surface of the snowboard, wherein the binding is configured to engage with the boot assembly when the boot assembly is in a first position relative to the binding, and to disengage from the boot assembly when the boot assembly is rotated to a second position relative to the binding.
